(19) United States
(12) Patent Application Publication
(10) Pub. No.: US 2023/0392096 A1
(43) Pub. Date: Dec. 7, 2023

(54) INDUSTRIAL AND INSTITUTIONAL CLEANING FOAM CONTROL AGENT

(71) Applicant: Dow Global Technologies LLC, Midland, MI (US)

(72) Inventors: Xiaolin Ma, Shanghai (CN); Xue Chen, Manvel, TX (US)

(21) Appl. No.: 18/248,537

(22) PCT Filed: Oct. 26, 2020
(86) PCT No.: PCT/CN2020/123537

§ 371 Date: Apr. 11, 2023

(51) Int. Cl. C11D 3/00; C11D 1/82; C11D 3/20; C11D 11/00

(52) U.S. Cl. CPC C11D 3/0026; C11D 1/82; C11D 3/2017; C11D 11/0029

(57) ABSTRACT

A foam control agent and method of controlling foam for Industrial and Institutional (I&I) cleaners by use of a foam control agent, wherein the agent comprises at least a branched alcohol.

Embodiments relate to a foam control agent and method of controlling foam for industrial and institutional (I&I) cleaning, wherein the agent comprises at least a branched alcohol.

### INTRODUCTION

Industrial and Institutional (I&I) cleaners are intended for cleaning institutions, warehouses, and industrial facilities. Surfactants are widely used to deliver penetrating, wetting, and emulsifying efficacy which facilitates the removal of soils. During cleaning operations, most surfactants generate foam because their surface activity stabilizes air in a liquid system. For example, anionic and nonionic surfactants with good detergency in industrial and institutional cleaners are usually foaming materials. In addition, cleaning in this area may require various operations including ultrasonic, high-pressure spraying, and intense mixing, which require strong foam control ability against the foaming materials. Thus, in many cases, foaming is not desired due to the reduced ability to rinse and/or overflows which lead to spills and product waste. It is common practice to add foam control agents which minimize foaming issues. A foam control agent includes a defoamer and/or an antifoamer. An antifoamer is designed to prevent foam, whereas a defoamer eliminates existing foam.

For I&I cleaning applications, one class of foam control agent includes block copolymers composed of ethylene oxide, propylene oxide, and/or butylene oxide. These types of products are believed to be effective since at increased temperatures they are insoluble in solution. This insolubility causes an increase in the surface tension of the system, which results in foam collapse. Another class of foam control agent includes polydimethylsiloxane (PDMS) materials. PDMS polymers are effective because they have low surface tensions and are also highly insoluble in water. With spreading over the foam, PDMS displaces surfactant molecules and thins out the lamellae, leading to foam destabilization and collapse.

With more attention to low temperature cleaning processes to save energy and resources, foam control at low temperatures has become an important aspect in product development. Common commercial dishwashing procedure, for example, including pre-wash utilizing manual dish detergent, usually contains high foaming anionic surfactants. Residue from the surfactant from pre-washing step may then be brought into the dishwasher and cause foam overflow in the tank. Currently, block copolymers or Polydimethylsiloxane (PDMS) materials are typically added to the surfactant formulas to suppress this foam and help reduce the amount of overflow. However, the performance of block copolymer is not satisfying and worse, PDMS has serious gelling issues on inner surface of commercial dishwashers.

For all these reasons and more, there is a need for a foam control agent and method of controlling foam for industrial cleaning.

### SUMMARY

Embodiments relate to a foam control agent and method of controlling foam for industrial cleaning, wherein the agent comprises at least a branched alcohol.

### BRIEF DESCRIPTION OF THE DRAWINGS

Various embodiments are disclosed in the following detailed description and accompanying drawings:

FIG. 1 is a chart of foam control performance of 2-PH in metal cleaner

FIG. 2 is a chart of foam control performance of 2-PH in rinsing aid

### DETAILED DESCRIPTION

The present disclosure relates to a foam control agent for Industrial and Institutional (I&I) cleaners. As previously discussed, ethylene oxide, propylene oxide, and/or butylene oxide are commonly used foam control agents. The present disclosure details how, unexpectedly, branched alcohols have been shown to have superior foam control performance. This performance is better at foam control than even alkoxylated copolymers (polyglycols, both diols and triols as initiator), which enables these materials to be utilized as foam control agents in Industrial and Institutional (I&I) cleaning applications. The branched alcohols may be 2-alkyl-1-alkanols (also known as Guerbet alcohols), and preferably 2-ethylhexanol (2-EH) and 2-propylheptanol (2-PH). These alcohols can be synthesized via the aldol condensation of the corresponding aldehydes or from the Guerbet reaction of primary linear alcohols. Other methods of production may also be utilized.

The generic structure of the antifoaming agent currently disclosed is as follows:

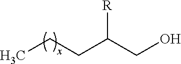

wherein x is an integer from 2 to 14 and R is an alkyl group with 1-14 carbon atoms.

The foam control agent may also be described as comprising a 2-alkyl substituted alcohol from C8-C32. The alcohols can be predominately one isomer (>95 wt. %) or a mixture of alcohols which can be generated by an aldol condensation of a mixture of aldehydes or generated from a mixture of alcohols via the Guerbet reaction.

The C8-C32 Guerbet alcohols including 2-ethylhexanol and 2-propylheptanol and the mixture of C8, C9, and C10 alcohols generated from the aldol condensation of butyraldehyde and valeraldehyde are preferred in some embodiments.

The concentration of the Guerbet alcohol in the formulated foam control agent ranges from 0.01% to 100%, preferably, ranging from 30% to 100% when used as antifoaming agent and ranging from 0.01% to 25% when used as defoaming agent. The Guerbet alcohol can be in the form of a solid or liquid, a liquid is preferred. If it is a solid, the material may be dissolved or dispersed in a solvent. The said foam control agent can be aqueous solution or organic solvent based solution. The usage dosage of the said foam control agent for Industrial and Institutional (I&I) cleaners ranges. The usage dosage of this foam control agent for cleaners ranges from 0.01% to 5%, preferably, ranges from 0.1% to 1%.

Other foam control agents (e.g., copolymers composed of ethylene oxide, propylene oxide, and/or butylene oxide, random or blocks) or other hydrophobic materials such as waxes, oils or silicas may also be added with the branched, Guerbet alcohol(s). Silicone can be used in conjunction with the 2-alkyl alcohols. Surfactants, especially alkoxylates of the alcohols can also be used. The use of branched alcohols as foam control agents may be water based or oil based.

The new foam control agent presently disclosed may be in the form of a solid or liquid. If it is a solid, the material may be dissolved or dispersed in a solvent before use as a foam control agent. The presently disclosed agents are believed to work in the presence of all commonly used industrial cleaners.

The chemical agent can be used both in antifoamer or defoamer formulations. Antifoamer formulations are obtained by the mixture of polyglycols, esters, silicones, solvents, water and/or other chemicals that in the gas-liquid interface of the bubble avoiding the foam formation. Other amphiphilic chemicals based on block copolymer can be used as well. In defoaming formulations, in addition to the products mentioned above, it can be used vegetable oils, mineral oils, waxes and other oily agents.

The optional surfactant or emulsifier contained in the foam control agent is selected to be suitable for improving the compatibility of the foam control agent on the feedstock or forming an emulsion with the composition of branched alcohol. The optional surfactant or emulsifier has an amount ranging from 0.1-30% by weight of the composition of branched alcohol.

The optional surfactant or emulsifier may be anionic, cationic or nonioic. Examples of suitable anionic surfactants or emulsifiers are alkali metal, ammonium and amine soaps; the fatty acid part of such soaps contains preferably at least 10 carbon atoms. The soaps can also be formed “in situ;” in other words, a fatty acid can be added to the oil phase and an alkaline material to the aqueous phase.

Other examples of suitable anionic surfactants or emulsifiers are alkali metal salts of alkyl-aryl sulfonic acids, sodium dialkyl sulfosuccinate, sulfated or sulfonated oils, e.g., sulfated castor oil; sulfonated tallow, and alkali salts of short chain petroleum sulfonic acids.

Suitable cationic surfactants or emulsifiers are salts of long chain primary, secondary or tertiary amines, such as oleylamide acetate, cetylamine acetate, di-dodecylamine lactate, the acetate of aminoethyl-aminoethyl stearamide, dilauroyl triethylene tetramine diacetate, 1-aminoethyl-2-heptadecenyl imidazoline acetate; and quaternary salts, such as cetylpyridinium bromide, hexadecyl ethyl morpholinium chloride, and diethyl di-dodecyl ammonium chloride.

Examples of suitable nonionic surfactants or emulsifiers are condensation products of higher fatty alcohols with ethylene oxide, such as the reaction product of oleyl alcohol with ethylene oxide units; condensation products of alkylphenols with ethylene oxide, such as the reaction product of isoctylphenol with 12 ethylene oxide units; condensation products of higher fatty acid amides with 5, or more, ethylene oxide units; polyethylene glycol esters of long chain fatty acids, such as tetraethylene glycol monopalmitate, hexaethyleneglycol monolaurate, nonaethyleneglycol monostearate, nonaethyleneglycol dioleate, tridecaethyleneglycol monoarachidate, tricosaethyleneglycol monobehenate, tricosaethyleneglycol dibehenate, polyhydric alcohol partial higher fatty acid esters such as sorbitan tristearate, ethylene oxide condensation products of polyhydric alcohol partial higher fatty acid esters, and their inner anhydrides (mannitol-anhydride, called Mannitan, and sorbitol-anhydride, called Sorbitan), such as glycerol monopalmitate reacted with 10 molecules of ethylene oxide, pentaerythritol monooleate reacted with 12 molecules of ethylene oxide, sorbitan monostearate reacted with 10-15 molecules of ethylene oxide, mannitan monopalmitate reacted with 10-15 molecules of ethylene oxide; long chain polyglycols in which one hydroxyl group is esterified with a higher fatty acid and other hydroxyl group is etherified with a low molecular alcohol, such as methoxypolyethylene glycol 550 monostearate (550 meaning the average molecular weight of the polyglycol ether). A combination of two or more of these surfactants may be used; e.g., a cationic may be blended with a nonionic or an anionic with a nonionic.

The foam control agent may further comprise one or more additives. Examples of additives include ethylene oxide/propylene oxide block copolymers, butylene oxide/propylene oxide block copolymers, ethylene oxide/butylene oxide block copolymers, waxes, or silicone-based materials. For other cleaning applications where surfactants cause foaming in cleaning steps Higher 2-alkyl substituted alcohols up to C32 can be used.

I&I cleaning may include, but it not limited to metal cleaning, food and beverage industrial cleaning, transportation cleaning, janitorial cleaning, commercial laundry, bathroom/kitchen cleaning and dishwashing, medical device cleaning, electronic cleaning, etc. The cleaning chemicals can be utilized to clean hard surfaces and/or soft surfaces.

### EXAMPLES

An experiment to test the efficacy of the presently disclosed foam control agent and others may be conducted as follows.

### Test 1—Foam Control Performance in Surfactant Solution

2-propylheptanol, 2-ethylhexanol and comparative examples were added into an aqueous solution of the foaming material to form a solution containing 0.1% of foaming media and 0.1% of foam control agent. Blank samples with 0.1% foaming material only were also prepared. Details of Example 1 and the other foaming samples can be found in Tables 1 and 2 below.

TABLE 1
Tested Formulations

| Example | Description | Source |
|---|---|---|
| Example 1 | 2-propylheptanol (2-PH, C10) | Sigma Aldrich |
| Example 2 | 2-ethylhexanol (2-EH, C8) | Sinopharm Chemical |
| | | Reagent Co. |
| Comparative | DOWFAX ™ DF-103 | The Dow Chemical |
| Example 1 | | Company |
| Comparative | TERGITOL ™ L-61 | The Dow Chemical |
| Example 2 | | Company |
| Comparative | Soybean oil | Soybeans |
| Example 3 | | |
| Comparative | Span 80 (Sorbitan | Sinopharm Chemical |
| Example 4 | Monooleate) | Reagent Co. |
| Comparative | Isostearylalcohol (C18) | Shandong Yuhuang |
| Example 5 | | Chemical |

TABLE 2
Foaming Samples

| Sample 1 | Sample 2 | Sample 3 | Sample 4 | Sample 5 | Sample 6 | Sample 7 | Sample 8 |
|---|---|---|---|---|---|---|---|
| 0.1% | 0.1% | 0.1% | 0.1% | 0.1% | 0.1% | 0.1% | 0.1% |
| Dish soap | Dish soap | Dish soap | Dish soap | Dish soap | Dish soap | Dish soap | Dish soap |
| | 0.1% | 0.1% | 0.1% | 0.1% | 0.1% | 0.1% | 0.1% |
| | 2-PH | 2-EH | DF-103 | L-61 | Soybean oil | Span 80 | Isostearylalcohol |
| Sample 9 | Sample 10 | Sample 11 | Sample 12 | Sample 13 | Sample 14 | Sample 15 | Sample 16 |
| 0.1% | 0.1% | 0.1% | 0.1% | 0.1% | 0.1% | 0.1% | 0.1% |
| AEO-7 | AEO-7 | AEO-7 | AEO-7 | AEO-7 | AEO-7 | AEO-7 | AEO-7 |
| | 0.1% | 0.1% | 0.1% | 0.1% | 0.1% | 0.1% | 0.1% |
| | 2-PH | 2-EH | DF-103 | L-61 | Soybean oil | Span 80 | Isostearylalcohol |

A High Throughput Robotics Machine (PICA II) was used to conduct a shake foam test of the samples. The machine had a mechanic arm that could shake the foam at a pre-set program of intensity and duration. After shaking was done, the solution was taken to a spot where a picture was taken to record the foam height. 2 g of test solution was filled in a standard glass bottle.

A shake foam test was also conducted at two temperatures—room temperature (RT, ˜22° C.) and 50° C. The outputs were exported in picture format. In order to have a quantitative perspective of the results, the foam heights were measured by pixels for comparison. The results of these tests can be found below in Tables 3-4

TABLE 3
Foam control evaluation for manual dish soap

| Sample | 1 | 2 | 3 | 4 | 5 | 6 | 7 | 8 |
|---|---|---|---|---|---|---|---|---|
| Foam control | None | 2-PH | 2-EH | DF-103 | L-61 | Soybean | Span 80 | Isostearyl |
| agent | | | | | | oil | | alcohol |
| Foam height | 208 | 56 | 68 | 108 | 124 | 107 | 119 | 196 |
| (pixel, RT) | | | | | | | | |
| Foam height | 247 | 48 | 75 | 118 | 65 | 211 | 210 | 181 |
| (pixel, 50° C.) | | | | | | | | |

TABLE 4
Foam control evaluation for AEO-7

| Sample | 9 | 10 | 11 | 12 | 13 | 14 | 15 | 16 |
|---|---|---|---|---|---|---|---|---|
| Foam control | None | 2-PH | 2-EH | DF-103 | L-61 | Soybean | Span 80 | Isostearyl |
| agent | | | | | | oil | | alcohol |
| Foam height | 200 | 46 | 94 | 234 | 204 | 186 | 99 | 48 |
| (pixel, RT) | | | | | | | | |
| Foam height | 246 | 40 | 51 | 52 | 183 | 205 | 112 | 33 |
| (pixel, 50° C.) | | | | | | | | |

As shown in the tables above, 2-propylheptanol was excellent in foam control against manual dish soap solution and AEO-7 solution at both room temperature and 50° C. Meanwhile, 2-ethylhexanol was less effective than 2-propylheptanol, but 2-ethylhexanol was more effective than other comparative examples. The results clearly demonstrate the effectiveness of 2-propylheptanol as foam control agent for I&I cleaning systems.

### Test 2—Foam Control Performance in Cleaning Formulations

2-PH was incorporated into metal cleaning and automatic dishwash rinsing aid formulations to check its foam control ability through comparison with blank formulas with no defoamer as control, as well as with formulas with same dosage of 2-EH or Comparative Example isostearylalcohol. The various details of the tested examples can be seen in Tables 5 and 7 below.

TABLE 5
Tested Formulations

| Example | Description |
|---|---|
| Example 1 | 2-propylheptanol (2-PH, C10) |
| Example 2 | 2-ethylhexanol (2-EH, C8) |
| Comparative Example 6 | Isostearylalcohol (C18) |

TABLE 6
Metal cleaner formula

| | | | | Control - |
|---|---|---|---|---|
| | | | w/ | w/o |
| Dosage (%) | w/2-PH | w/2-EH | Isostearylalcohol | defoamer |
| Water | 84.7 | 84.7 | 84.7 | 85 |
| ECOSURF ™ LFE- | 3 | 3 | 3 | 3 |
| 635 | | | | |
| Sodium | 2 | 2 | 2 | 2 |
| Metasilicate | | | | |
| nonahydrate | | | | |
| NaOH | 1 | 1 | 1 | 1 |
| Sodium Carbonate | 3 | 3 | 3 | 3 |
| TRITON ™ H-66 | 6 | 6 | 6 | 6 |
| Defoamer | 0.3 | 0.3 | 0.3 | 0 |

TABLE 7
Automatic dishwash rinsing aid formula

| | | | | Control - |
|---|---|---|---|---|
| | | | w/ | w/o |
| Dosage (%) | w/2-PH | w/2-EH | Isostearylalcohol | defoamer |
| Water | 87.08 | 87.08 | 87.08 | 87.68 |
| Citric Acid | 1 | 1 | 1 | 1 |
| Sodium | 2.22 | 2.22 | 2.22 | 2.22 |
| Cumene | | | | |
| Sulfonate (90%) | | | | |
| DOWFAX ™ | 6 | 6 | 6 | 6 |
| 20B102 | | | | |
| ECOSURF ™ | 3 | 3 | 3 | 3 |
| LFE-635 | | | | |
| Defoamer | 0.6 | 0.6 | 0.6 | 0 |

FoamScan equipment was utilized to evaluate the foaming and defoaming properties of the solutions. The mechanism was to inject gas at a pre-set rate to generate foam and then stop gas injection to observe foam collapse. Both formulas were diluted before testing to mimic real cleaning conditions. The foaming test program for the cleaners was shown below in Table 8.

TABLE 8
Foaming test parameters

| | Metal cleaner | Dishwash rinsing aid |
|---|---|---|
| Dilution rate | 1:10 | 1:1000 |
| Gas strength (ml/min) | 300 | 410 |
| Gas injection time (s) | 40 | 60 |
| Total time (s) | 100 | 120 |
| Temperature (° C.) | 50 | 50 |

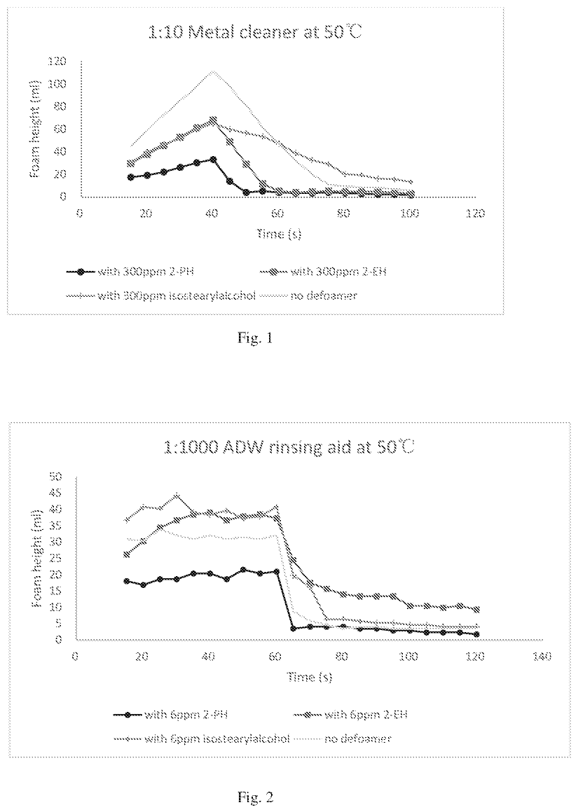

FIGS. 1 and 2 show the foaming test results of the metal cleaners and dishwash rinsing aids respectively. As shown in these figures, amongst the defoamer samples, 2-PH showed best foam control ability. 2-EH inhibited foam in the metal cleaner but was less effective than 2-PH. 2-EH did not decrease foam in the dishwash rinsing aid. Isostearylalcohol did not act as an effective defoamer. Thus, 2-PH is a surprisingly effective foam control agent and 2-EH also provides useful foam control.

1. (canceled)

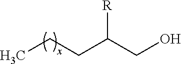

2. (canceled)

3. (canceled)

4. (canceled)

5. A method of controlling foam for industrial or institutional cleaners by use of a foam control agent, wherein the agent comprises at least a branched alcohol that has the structure of: 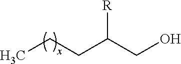
wherein x is an integer from 2 to 14 and R is an alkyl group with 1-14 carbon atoms, where the branched alcohol has from 8 to 10 carbon atoms.

6. The method of claim 5, wherein at least one other foam control agent or hydrophobic material is used.

7. The method of claim 5, wherein silicone is also used.

8. (canceled)
